(19) United States
(12) Patent Application Publication
(10) Pub. No.: US 2025/0244579 A1
(43) Pub. Date: Jul. 31, 2025

(54) DISPLAY MODULE

(71) Applicants: Innolux Corporation, Miaoli County (TW); CARUX TECHNOLOGY PTE. LTD., SINGAPORE (SG)

(72) Inventors: Yu-Chia Huang, Miaoli County (TW); Yu-Hsuan Hsiao, Tainan (TW); Tsung-Han Tsai, Miaoli County (TW); Yu-Chien Kao, Tainan (TW)

(73) Assignees: Innolux Corporation, Miaoli County (TW); CARUX TECHNOLOGY PTE. LTD., SINGAPORE (SG)

(21) Appl. No.: 19/002,768

(22) Filed: Dec. 27, 2024

Related U.S. Application Data
(60) Provisional application No. 63/626,505, filed on Jan. 29, 2024.

(30) Foreign Application Priority Data
Oct. 17, 2024 (CN) 202411454696.5

(51) Int. Cl. G02B 27/01; B60K 35/231; G02B 27/09

(52) U.S. Cl. CPC G02B 27/0101; B60K 35/231; G02B 27/0977; B60K 2360/688; B60K 2360/693; B60K 2360/785; G02B 2027/0118

(57) ABSTRACT

A display module is provided, which is disposed adjacent to a windshield. The display module includes a display, an optical film, and at least one light absorption component. The display includes a display region and a peripheral region, and is configured to provide display light with a first polarization direction. The optical film is disposed between the display and the windshield, and the optical film is configured to reflect the display light with the first polarization direction. The at least one light absorption component is disposed adjacent to at least one side of the peripheral region, and is separated from the display by a distance.

### CROSS-REFERENCE TO RELATED APPLICATION

This application claims the priority benefits of U.S. provisional application Ser. No. 63/626,505, filed on Jan. 29, 2024, and China application serial no. 202411454696.5, filed on Oct. 17, 2024. The entirety of each of the above-mentioned patent applications is hereby incorporated by reference herein and made a part of this specification.

### BACKGROUND

### Technical Field

The disclosure relates to a display module.

### Description of Related Art

With the flourishing development of automotive display technology, consumers are becoming increasingly demanding for display products used in vehicles. Among various types of display products, the head-up display (HUD) technology utilizes the windshield to reflect display light, allowing the display light to be transmitted to the user (or driver) via reflection and enabling the user to see the image displayed when facing the windshield. Now head-up displays are gradually becoming widespread in the market and popular among consumers.

However, the windshield is required to have a certain light transmittance for the driver to see the road ahead through ambient light from outside the windshield. Consequently, when the driver looks at the image provided by the head-up display, the ambient light seen by the driver through the windshield may easily result in a decrease in contrast and clarity of the displayed image. When the ambient light is too strong (for example, in an environment with strong sunlight during the day), it may also seriously affect the viewing experience of the head-up display. Furthermore, when the ambient light irradiates the display or accessories thereof, unexpected reflection from the environment may form stray light, causing inconvenience to the user or affecting driving safety. All these are the issues that manufacturers intend to solve.

### SUMMARY

The disclosure provides a display module with improved display quality.

According to an embodiment of the disclosure, a display module is disposed adjacent to a windshield. The display module includes a display, an optical film, and at least one light absorption component. The display includes a display region and a peripheral region, and is configured to provide display light with a first polarization direction. The optical film is disposed on a side adjacent to a light-emitting surface of the display, and the optical film is configured to reflect the display light with the first polarization direction. The at least one light absorption component is disposed adjacent to at least one side of the peripheral region, and is separated from the display by a distance.

Several exemplary embodiments accompanied with drawings are described in detail below to further describe the disclosure.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic diagram showing the structure of a display module according to an embodiment of the disclosure;

FIG. 1B is a schematic diagram showing the virtual image caused by stray light of the display module in FIG. 1A;

FIG. 2A is a schematic diagram showing the structure of a display module according to an embodiment of the disclosure;

FIG. 2B is a schematic diagram showing various forms of implementation of the microstructures of the display module in FIG. 2A;

FIG. 3 is a schematic diagram showing the structure of a display module according to an embodiment of the disclosure;

FIG. 4 is a schematic diagram showing the structure of a display module according to an embodiment of the disclosure;

FIG. 5 is a schematic diagram showing the structure of a display module according to an embodiment of the disclosure;

FIG. 6 is a schematic diagram showing the structure of a display module according to an embodiment of the disclosure;

FIG. 7A is a schematic diagram showing the structure of a display module according to an embodiment of the disclosure;

FIG. 7B is a graph showing the relationship between the incident angle and the reflection coefficient for a light beam with the first polarization direction and a light beam with the second polarization direction when passing through different media; and

FIG. 8 is a schematic diagram showing the structure of a display module according to an embodiment of the disclosure.

### DETAILED DESCRIPTION OF DISCLOSED EMBODIMENTS

Reference will now be made in detail to the exemplary embodiments of the disclosure, examples of which are illustrated in the accompanying drawings. Whenever possible, the same reference numbers are used in the drawings and the description to refer to the same or like parts.

Certain terminologies are used throughout the specification and appended claims of the disclosure to refer to specific elements. Any person having ordinary knowledge in the art should understand that electronic device manufacturers may refer to the same elements by different names. The disclosure does not intend to distinguish between elements that have the same function but different names. In the following specification and claims, terminologies such as “including,” “containing,” and “having” are open-ended terminologies, so should be interpreted as meaning “including but not limited to . . . ”

The directional terminologies mentioned in the disclosure, such as “upper,” “lower,” “front,” “rear,” “left,” “right,” and so on, are used with reference to the accompanying drawings. Therefore, the directional terminologies are used for illustration, but not to limit the disclosure. In the accompanying drawings, each drawing shows the general features of the methods, structures and/or materials adopted in a specific embodiment. However, the drawings should not be construed as defining or limiting the scope or nature covered by the embodiments. For instance, for clarity, the relative size, thickness, and position of each layer, region, and/or structure may be reduced or enlarged.

When a structure (or layer, element, substrate) is referred to as being located “on/above” another structure (or layer, element, substrate) in the disclosure, it may mean that the two structures are adjacent and directly connected, or it may mean that the two structures are adjacent but not directly connected. “Indirect connection” means that there is at least one intermediary structure (or intermediary layer, intermediary element, intermediary substrate, intermediary spacer) between the two structures, in which the lower surface of a structure is adjacent to or directly connected to the upper surface of the intermediary structure, and the upper surface of the other structure is adjacent to or directly connected to the lower surface of the intermediary structure. The intermediary structure may be a single-layer or multi-layer physical or non-physical structure, and there is no limitation. In the disclosure, when a structure is disposed “on” another structure, it may mean that the structure is “directly” on another structure, or that the structure is “indirectly” on another structure, with at least one structure sandwiched between the two structures.

The terminologies “about,” “substantially,” and “approximately” are generally interpreted as being within 10% of the given value or range, or interpreted as being within 5%, 3%, 2%, 1%, or 0.5% of the given value or range. In addition, the terminologies “a given range is a first value to a second value” and “a given range falls within a range of a first value to a second value” means that the given range includes the first value, the second value, and other values in between.

The ordinal numbers used in the specification and claims, such as the terminologies “first,” “second,” and the like, to qualify an element do not imply or represent that the element or elements are preceded with any ordinal numbers, nor do they represent the order of a certain element and another element, or the order in the manufacturing method, and are used for clearly distinguishing an element with one name from another element with the same name. Different terminologies may be used in the claims and the specification, and accordingly, a first element in the specification may be a second element in the claims.

The electrical connection or coupling described in the disclosure may refer to direct connection or indirect connection. In the case of direct connection, the endpoints of the elements on two circuits are directly connected or are connected to each other by a conductor segment. In the case of indirect connection, between the endpoints of the elements on two circuits, there are switches, diodes, capacitors, inductances, resistors, other suitable elements, or a combination of the above-mentioned elements, but the disclosure is not limited thereto.

In the disclosure, the thickness, length, and width may be measured by applying an optical microscope (OM), while the thickness or width may be measured from cross-sectional images in an electron microscope, which should however not be construed as a limitation in the disclosure. Additionally, there may be a certain margin of error between any two values or directions applied for comparison. In addition, the phrase “a given range is a first value to a second value,” “a given range falls within a range of a first value to a second value,” or “a given range is between a first value and a second value” means that the given range includes the first value, the second value, and other values in between. If a first direction is perpendicular to a second direction, the angle between the first direction and the second direction may be between 80 degrees and 100 degrees. If the first direction is parallel to the second direction, the angle between the first direction and the second direction may be between 0 degrees and 10 degrees.

Unless otherwise defined, all terminologies (including technical and scientific terminologies) used herein have the same meaning as commonly understood by any person having ordinary knowledge in the art to which the disclosure belongs. It is understood that these terminologies, such as those defined in commonly used dictionaries, should be interpreted as having meanings consistent with the relevant art and the background or context of the disclosure, and should not be interpreted in an idealized or overly formal way, unless otherwise defined in the embodiments of the disclosure.

The electronic device disclosed in the specification may include a display device, a backlight device, an antenna device, a packaging device, a sensing device, or a tiled device, but is not limited thereto. The electronic device may be a foldable or flexible electronic device. The display device may be a non-self-luminous display device or a self-luminous display device. The electronic device may include, for instance, liquid crystal, light-emitting diode, fluorescence, phosphor, quantum dot (QD), other suitable display media, or a combination of the foregoing. The antenna device may include, for instance, a reconfigurable intelligent surface (RIS), a frequency selective surface (FSS), an RF-filter, a polarizer, a resonator, an antenna, and so on. The antenna device may be a liquid crystal antenna device or varactor diodes. The sensing device may be a sensing device for sensing capacitance, light, heat, or ultrasonic waves, but is not limited thereto. In the disclosure, the electronic device may include electronic elements, and the electronic elements may include passive elements and active elements, such as capacitors, resistors, inductors, diodes, transistors, and the like. The diodes may include light-emitting diodes, varactor diodes, or photodiodes. The light-emitting diodes may include, for instance, organic light-emitting diodes (OLED), mini LEDs, micro LEDs, or quantum dot LEDs, but is not limited thereto. The tiled device may be, for instance, a display tiled device or an antenna tiled device, but is not limited thereto. It should be noted that the electronic device may be any combination of the foregoing, but is not limited to thereto. The packaging device may be suitable for wafer-level package (WLP) technology or panel-level package (PLP) technology, such as chip first process or RDL first process packaging devices. In addition, the appearance of the electronic device may be rectangular, circular, polygonal, in a shape with curved edges, or in other suitable shapes. The electronic device may have peripheral systems such as a driving system, a control system, a light source system, and the like so as to support a display device, an antenna device, a wearable device (for example, including augmented reality or virtual reality), an in-vehicle device (for example, including car windshield), or a tiled device.

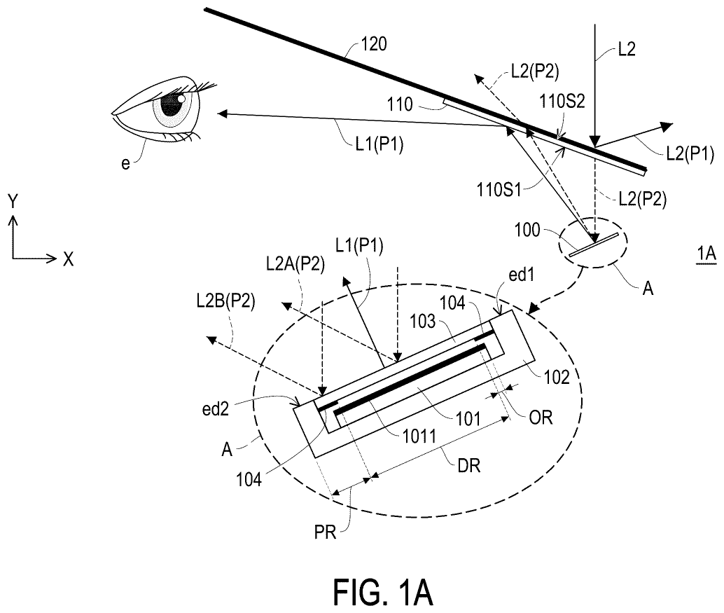

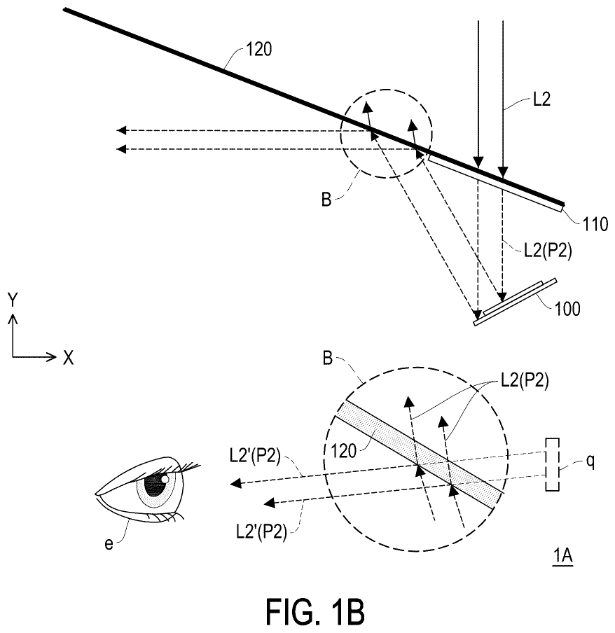

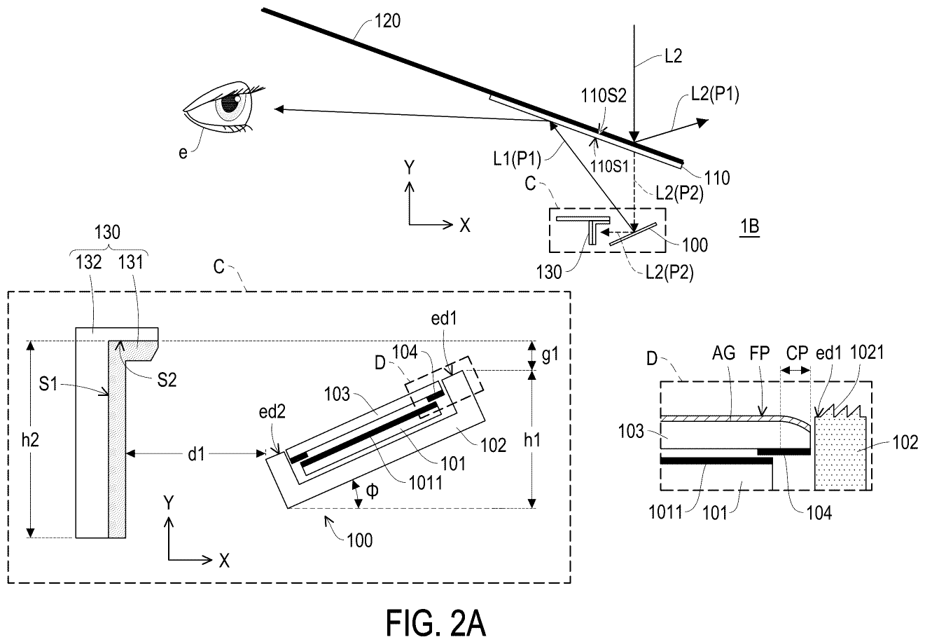

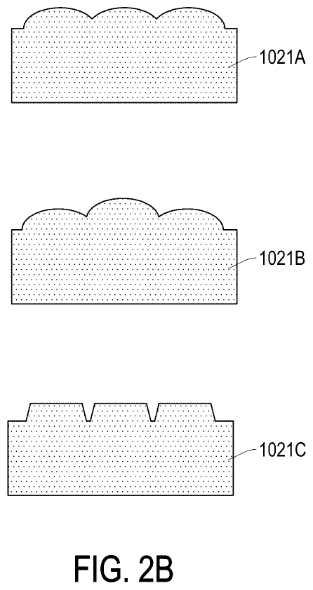

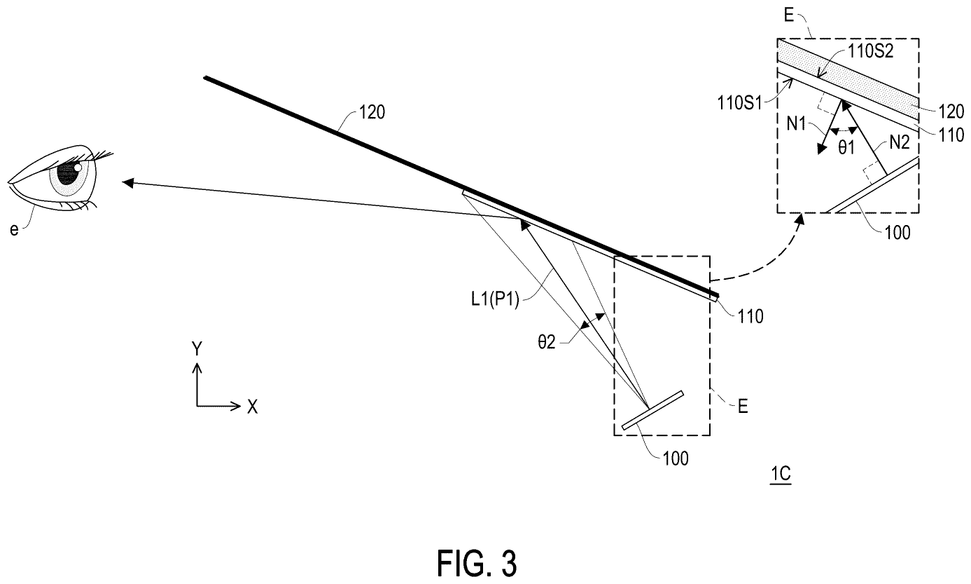

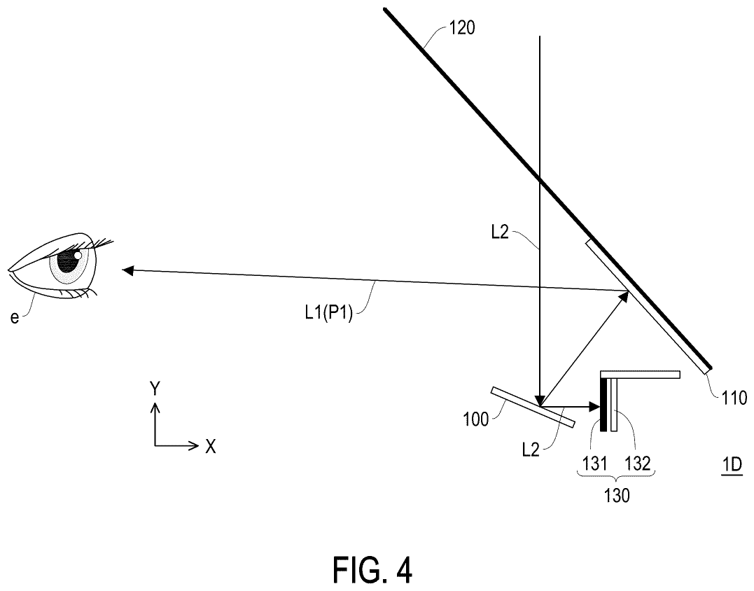

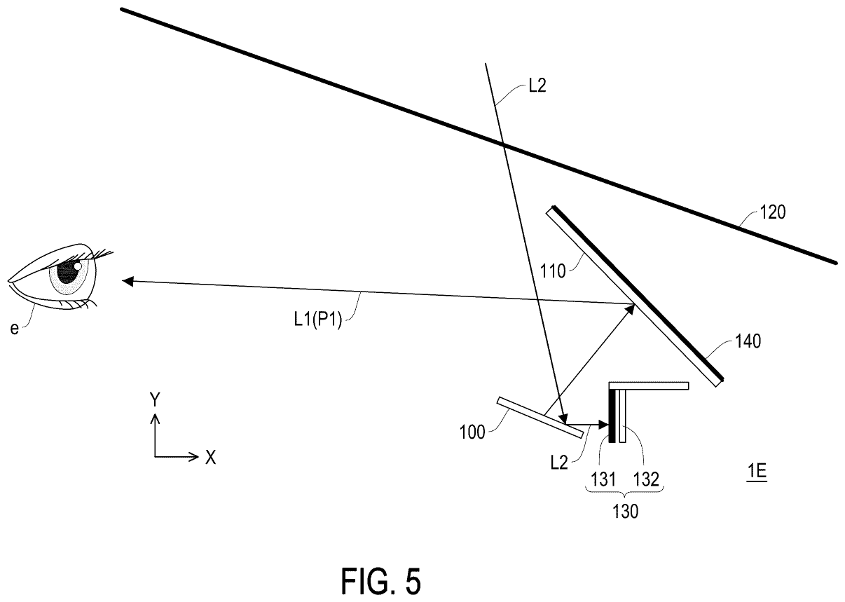

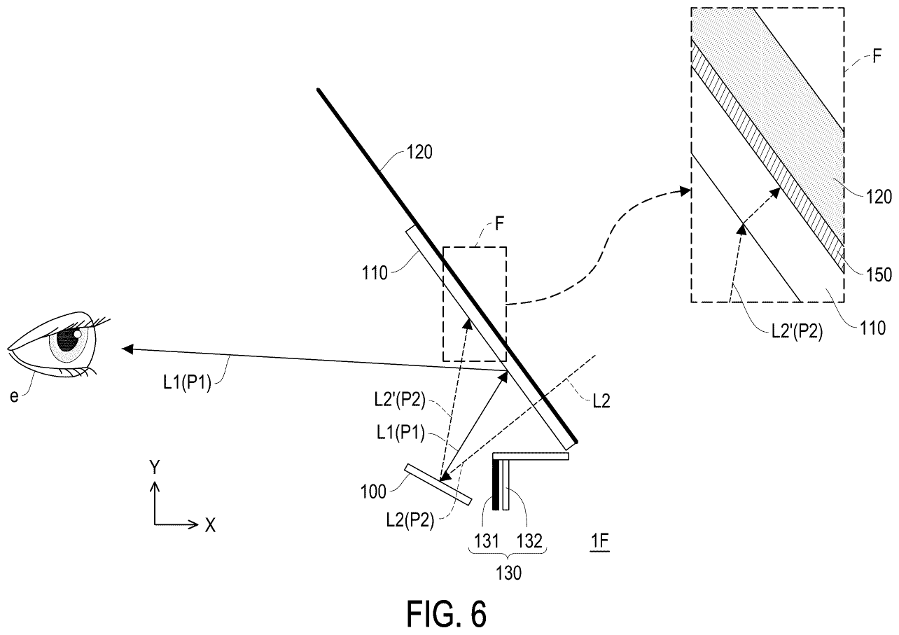

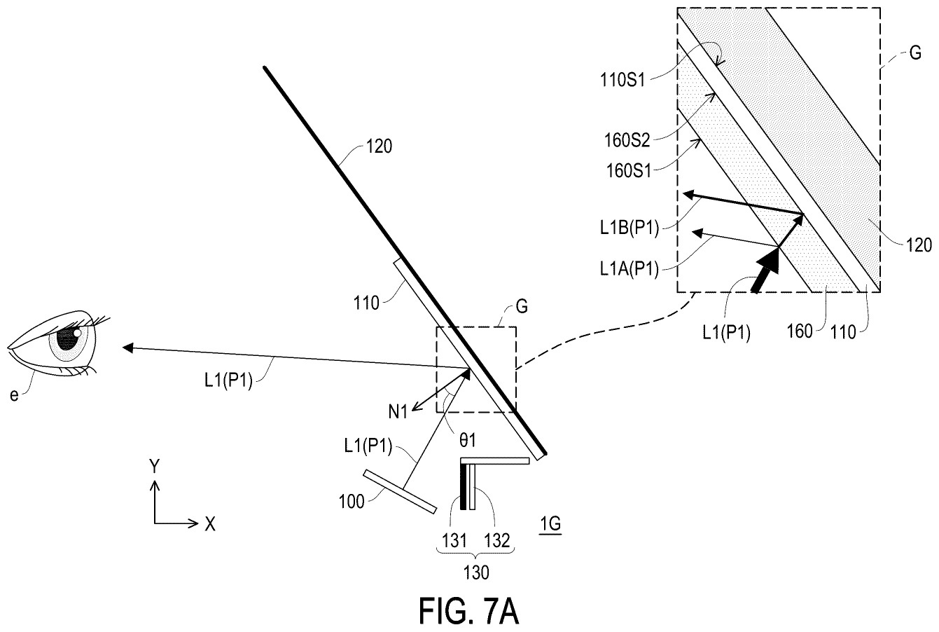

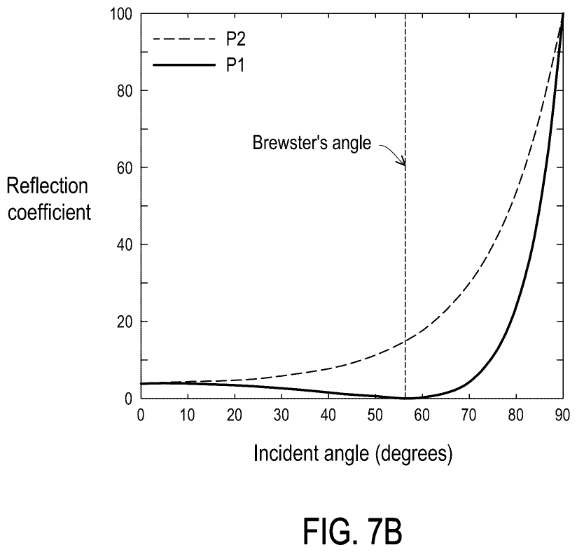

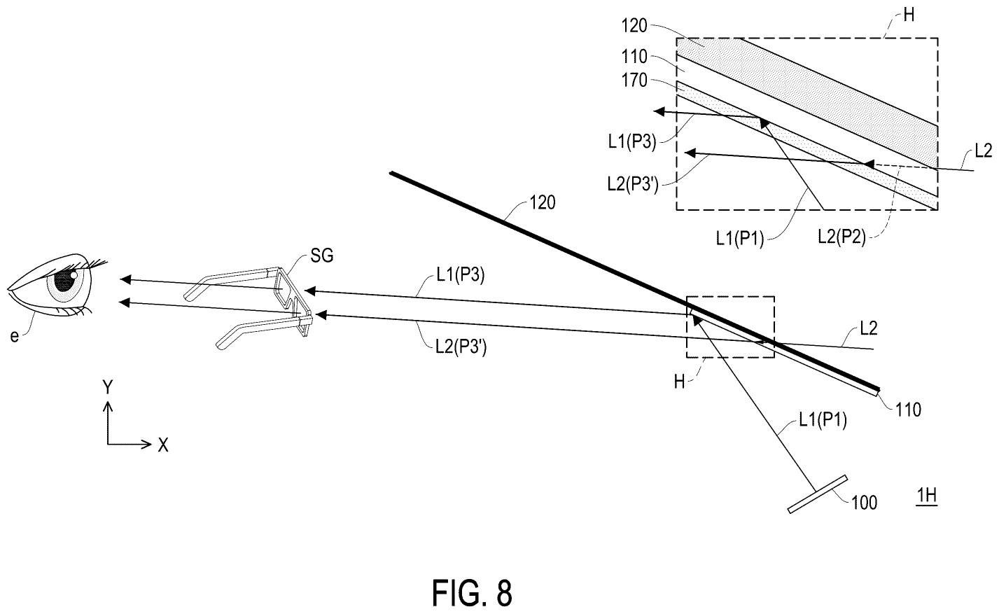

FIG. 1A is a schematic diagram showing the structure of a display module according to an embodiment of the disclosure. FIG. 1B is a schematic diagram showing the virtual image caused by stray light of the display module in FIG. 1A. FIG. 2A is a schematic diagram showing the structure of a display module according to an embodiment of the disclosure. FIG. 2B is a schematic diagram showing various forms of implementation of the microstructures of the display module in FIG. 2A. FIG. 3 is a schematic diagram showing the structure of a display module according to an embodiment of the disclosure. FIG. 4 is a schematic diagram showing the structure of a display module according to an embodiment of the disclosure. FIG. 5 is a schematic diagram showing the structure of a display module according to an embodiment of the disclosure. FIG. 6 is a schematic diagram showing the structure of a display module according to an embodiment of the disclosure. FIG. 7A is a schematic diagram showing the structure of a display module according to an embodiment of the disclosure. FIG. 7B is a graph showing the relationship between the incident angle and the reflection coefficient for a light beam with the first polarization direction and a light beam with the second polarization direction when passing through different media. FIG. 8 is a schematic diagram showing the structure of a display module according to an embodiment of the disclosure. It should be noted that, in the following embodiments, features from several different embodiments may be replaced, recombined, or mixed to complete other embodiments without departing from the spirit of the disclosure. The features from various embodiments may be arbitrarily combined for use as long as the features do not violate the spirit of the disclosure or conflict with each other.

In the embodiments of the disclosure, the display module may be used on a vehicle with a windshield. The windshield may be safety glass with a laminated structure or the like, but the disclosure is not limited thereto. Moreover, the disclosure herein is not intended to limit the vehicle to a certain type. In terms of power source, the vehicle may be a gasoline vehicle, a diesel vehicle, a hybrid vehicle, or an electric vehicle, but is not limited thereto. In terms of appearance or function, the vehicle may be a sedan, an SUV, a sports car, a truck, a bus, a military vehicle, a racing car, a special purpose vehicle, a construction vehicle, or a camper, but is not limited thereto.

Referring to FIG. 1A and FIG. 1B, the display module 1A includes a display 100, an optical film 110, and a windshield 120, but is not limited thereto. One or more components may be added to or omitted from the display module 1A as required.

The display 100 includes a display region DR and a peripheral region PR, and the display 100 is configured to provide display light L1 with a first polarization direction P1. Specifically, the display region DR is a region for the display 100 to provide an image, and the peripheral region PR is a region outside the display region DR. The peripheral region PR may be configured to dispose a peripheral circuit (not shown), a driving component (not shown), or other components (not shown) that are not intended to be seen by the user. The peripheral region PR may be located on at least one side of the display region DR. For example, the peripheral region PR may surround the display region DR, but is not limited thereto.

The display 100 may include a liquid crystal display, a light-emitting diode (LED) display, a fluorescence display, a phosphor display, a digital light processing (DLP) projector, a liquid crystal on silicon (LCOS) display, a laser scanning system, or any combination of the foregoing, but is not limited thereto. The liquid crystal display may include a thin-film transistor display, but is not limited thereto. The digital light processing projector may include a digital micromirror device (DMD) or a zoom projector, but is not limited thereto. The light-emitting diode may include, for example, an organic light-emitting diode (OLED), an inorganic light-emitting diode, a mini LED, a micro LED, or a quantum dot (QD) light-emitting diode (QLED, QDLED), other suitable materials, or any combination of the foregoing, but is not limited thereto. Moreover, the shape of the display 100 may be rectangular, or may be circular, polygonal, a shape with curved edges, or other suitable shapes in other embodiments. Nevertheless, the disclosure is not limited thereto.

The optical film 110 is disposed on a side adjacent to the light-emitting surface of the display 100, or the optical film 110 is disposed between the display 100 and the windshield 120 in the direction Y. Specifically, the optical film 110 may be attached to the windshield 120 via an adhesive layer (not shown). For example, the optical film 110 is attached to the side of the windshield 120 facing the driver (that is, an eye e in FIG. 1A). The optical film 110 is disposed on the transmission path of the display light L1. Furthermore, the optical film 110 is configured to reflect the display light L1 with the first polarization direction P1, so that the display light L1 is redirected and transmitted to the eye e of the driver. The optical film 110 may be a polarizing beam splitter film or a reflective polarizing film, which has different reflectances and transmittances for light beams in different polarization states. For example, the optical film 110 has a first reflectance and a first transmittance for a light beam with the first polarization direction P1 (for example, display light L1), and the optical film 110 has a second reflectance and a second transmittance for a light beam with the second polarization direction P2 (for example, initial ambient light L2), wherein the first reflectance is greater than the second reflectance, and the first transmittance is less than the second transmittance.

The light beam with the first polarization direction P1 is, for example, P-type polarized light, and the light beam with the second polarization direction P2 is, for example, S-type polarized light. The reflection axis of the optical film 110 is, for example, parallel to the P-type polarized light, so that the optical film 110 has a higher first reflectance and a lower first transmittance for the display light L1 with the first polarization direction P1; and the transmission axis of the optical film 110 is, for example, parallel to the S-type polarized light, so that the optical film 110 has a lower second reflectance and a higher second transmittance for a S-type polarized light beam. In the case where the display light L1 emitted by the display 100 is P-type polarized light, the optical film 110 has a higher first reflectance for the display light L1, allowing most of the display light L1 to be transmitted to the optical film 110 and be reflected to the eye e by the optical film 110, thereby improving the display quality and clarity.

The optical film 110 has a first surface 110S1 and a second surface 110S2. The first surface 110S1 is the surface of the optical film 110 facing the display 100, and the second surface 110S2 is the surface of the optical film 110 facing the windshield 120. The display light L1 is incident on the first surface 110S1, and the initial ambient light L2 from outside the windshield 120 is incident on the second surface 110S2. The initial ambient light L2 is, for example, non-polarized light. That is, the polarization direction of the initial ambient light L2 includes the first polarization direction P1 and the second polarization direction P2. The optical film 110 is configured to transmit the initial ambient light L2 with the second polarization direction P2 and reflect the initial ambient light L2 with the first polarization direction P1.

When the initial ambient light L2 reaches the second surface 110S2 of the optical film 110, the optical film 110 has a higher second transmittance and a lower second reflectance for the initial ambient light L2 with the second polarization direction P2, and the optical film 110 has a higher first reflectance and a lower first transmittance for the initial ambient light L2 with the first polarization direction P1. In other words, most of the initial ambient light L2 with the first polarization direction P1 is reflected by the optical film 110, and most of the initial ambient light L2 with the second polarization direction P2 passes through the optical film 110. The initial ambient light L2 with the second polarization direction P2 that passes through the optical film 110 is then reflected back to the optical film 110 by the display 100. Since the optical film 110 has a higher second transmittance and a lower second reflectance for the initial ambient light L2 with the second polarization direction P2, most of the initial ambient light L2 with the second polarization direction P2 passes through the optical film 110 again rather than being reflected to the eye e of the user by the optical film 110. Thus, the intensity of the initial ambient light L2 that enters the eye e of the user is effectively reduced, which means that the proportion of stray light generated is reduced, thereby improving the display quality of the display module 1A.

In some embodiments, the first reflectance (reflectance for a light beam with the first polarization direction P1) of the optical film 110 may, for example, be greater than or equal to 40% and less than or equal to 60%, and the second reflectance (reflectance for a light beam with the second polarization direction P2) may be greater than 0% and less than or equal to 20%. Furthermore, the first transmittance (transmittance for a light beam with the first polarization direction P1) of the optical film 110 may be greater than or equal to 40% and less than or equal to 60%, and the second transmittance (transmittance for a light beam with the second polarization direction P2) may be greater than or equal to 80% and less than 100%.

In some embodiments, the reflectance of the optical film 110 may be greater than or equal to 25% and less than or equal to 35%, and the transmittance of the optical film 110 may be greater than or equal to 65% and less than or equal to 75%. Here, the reflectance of the optical film 110 refers to the average value of the sum of the reflectance of the optical film 110 for a light beam with the first polarization direction P1 and the reflectance of the optical film 110 for a light beam with the second polarization direction P2, that is, (first reflectance+second reflectance)/2. On the other hand, the transmittance of the optical film 110 refers to the average value of the sum of the transmittance of the optical film 110 for a light beam with the first polarization direction P1 and the transmittance of the optical film 110 for a light beam with the second polarization direction P2, that is, (first transmittance+second transmittance)/2. An appropriate design of the transmittance and reflectance of the optical film 110 helps to improve the display quality while allowing the driver to see the scene outside the windshield 120, thereby ensuring driving safety.

Next, referring to region A in FIG. 1A, in some embodiments, the display 100 may include a display panel 101, a frame 102, a cover plate 103, and a light-shielding layer 104. The display panel 101 is configured to provide the display light L1. A polarizer 1011 may be disposed on the light-emitting side of the display panel 101, so that the display light L1 emitted from the display panel 101 has the first polarization direction P1. The frame 102 is configured to accommodate the display panel 101. In some embodiments, the material of the frame 102 may include metal, an alloy, or a combination thereof to facilitate heat dissipation, but is not limited thereto. The frame 102 has an opening formed by surrounding side edges (for example, a first side edge ed1 and a second side edge ed2 are partially shown in FIG. 1A), and the cover plate 103 is disposed at the opening. The cover plate 103 is disposed on the light-emitting surface of the display panel 101. The material of the cover plate 103 is, for example, a high-transmittance polymer (such as polycarbonate (PC), polyimide (PI), polypropylene (PP), and polyethylene terephthalate (PET)) or glass, but the disclosure is not limited thereto. The light-shielding layer 104 is disposed on the cover plate 103 and located at the edge of the cover plate 103. The light-shielding layer 104 may partially overlap the display panel 101, for example, having an overlapping region OR as shown in FIG. 1A. The design of the overlapping region OR allows the edge of the display panel 101 to be effectively shielded by the light-shielding layer 104, which reduces visual discontinuity and blurs the edge of the display panel 101. Here, the peripheral region PR of the display 100 may include a part of the cover plate 103 (for example, the part of the cover plate 103 overlapping the light-shielding layer 104), the frame 102, and the light-shielding layer 104. From another perspective, the display region DR of the display 100 may be a region of the display panel 101 that is not shielded by the light-shielding layer 104, and the peripheral region PR may be a region outside the display region DR. The light-shielding layer 104 may include, for example, a dark ink to provide a certain light-shielding effect. For instance, the optical density (OD) value of the light-shielding layer 104 may be greater than or equal to 2, but the disclosure is not limited thereto. The light-shielding layer 104 may be used to beautify the appearance or cover components, circuit boards, or wires underneath that are not intended to be seen by the user. In some embodiments, the light-shielding layer 104 may include a patterned dark ink. For example, the light-shielding layer 104 may include regularly or irregularly arranged dot patterns, and these dot patterns gradually increase in size, deepen in color, or increase in density from the display region DR toward the peripheral region PR. This design can improve the optical aesthetics. The patterned design of the light-shielding layer 104 can reduce the sudden color change at the edge of the display 100. In some embodiments, the light-shielding layer 104 may partially cover the peripheral region PR without completely filling the peripheral region PR, but the disclosure is not limited thereto.

In some embodiments, the initial ambient light L2 with the second polarization direction P2 that passes through the optical film 110 may be sequentially reflected by the display 100 and the windshield 120 to be transmitted to the eye e of the driver. As shown in FIG. 1B, part of the initial ambient light L2 with the second polarization direction P2 may pass through the optical film 110 to be transmitted to the display region DR of the display 100. This part of the initial ambient light L2 is sequentially reflected by the display region DR of the display 100 and the windshield 120, and transmitted to the eye e of the driver. Furthermore, another part of the initial ambient light L2 with the second polarization direction P2 may pass through the optical film 110 and be transmitted to the peripheral region PR of the display 100. This another part of the initial ambient light L2 is then sequentially reflected by the peripheral region PR of the display 100 and the windshield 120, and transmitted to the eye e of the driver. In some embodiments, the display module 1A may be further designed to reduce the differences (such as differences in color, brightness, and/or color temperature) of the initial ambient light L2 from the display region DR and the peripheral region PR of the display 100, thereby homogenizing the initial ambient light L2 reflected to the eye e and reducing the influence of stray light on the user.

TABLE 1-1

| | Measurement point | |
|---|---|---|
| | Surface of | Surface of |
| | display 100 | display 100 |
| | Type of light measured | |
| | | Polarized |
| | Non-polarized | light with second |
| | light | polarization direction |
| Difference in | 3% | 1.5% |
| reflectance (ΔR %) | | |
| Difference in specular | 3% | 1.5% |
| reflectance | | |
| (\|SCI-SCE\|) | | |
| Difference in color | 10.0 | 10.0 |
| difference (ΔE) | | |

TABLE 1-2

| | Measurement point | |
|---|---|---|
| | Surface of | Surface of |
| | windshield 120 | windshield 120 |
| | Type of light measured | |
| | | Polarized |
| | Non-polarized | light with second |
| | light | polarization direction |
| Difference in | 1.1% | 0.5% |
| brightness (ΔL) | | |
| Difference in color | 7.0 | 7.0 |
| difference (ΔE) | | |
| Difference in color | 1000 | 1000 |
| temperature | | |
| (ΔK) | | |

TABLE 2-1

| | Measurement point | |
|---|---|---|
| | Surface of | Surface of |
| | display 100 | display 100 |
| | Type of light measured | |
| | | Polarized |
| | Non-polarized | light with second |
| | light | polarization direction |
| Difference in reflectance | 1% | 0.5% |
| Difference in specular | 1% | 0.5% |
| reflectance | | |
| Difference in color | 6.0 | 6.0 |
| difference | | |

TABLE 2-2

| | Measurement point | |
|---|---|---|
| | Surface of | Surface of |
| | windshield 120 | windshield 120 |
| | Type of light measured | |
| | | Polarized |
| | Non-polarized | light with second |
| | light | polarization direction |
| Difference in brightness | 0.4% | 0.2% |
| Difference in color | 4.2 | 2.1 |
| difference | | |
| Difference in color | 500 | 500 |
| temperature | | |

In Table 1-1 and Table 2-1, the difference in reflectance, the difference in specular reflectance, and the difference in color difference refer to the differences in reflectance, specular reflectance, and color difference of the initial ambient light L2 from the display region DR and the peripheral region PR of the display 100. These may be measured by setting a detection device above the display surface of the display 100. In Table 1-1 and Table 2-1, the difference in color difference ΔE=(a*\hat{ }2+b*\hat{ }2+L*\hat{ }2)\hat{ }0.5, where a*, b*, and L* are the three color coordinates in the CIE color space.

In Table 1-2 and Table 2-2, the difference in brightness, the difference in color difference, and the difference in color temperature refer to the differences in brightness, color difference, and color temperature of the initial ambient light L2 from the display region DR and the peripheral region PR of the display 100. These may be measured by setting a detection device at the position of the eye e to capture the initial ambient light L2 from the display region DR and the peripheral region PR of the display 100. In Table 1-2 and Table 2-2, K refers to color temperature, and K=437*n\hat{ }3+3601*n\hat{ }2+6831*n+5517, where n=(x−0.3320)/(0.1858−y), and x and y are the two color coordinates in the CIE 1931 color space.

Similarly, Table 2-1 shows the differences in reflectance, specular reflectance, and color difference when a non-polarized light beam irradiates the display region DR and the peripheral region PR of the display 100 according to another embodiment; and the differences in reflectance, specular reflectance, and color difference when a light beam with the second polarization direction P2 irradiates the display region DR and the peripheral region PR of the display 100 according to another embodiment. Table 2-2 shows the differences in brightness, color difference, and color temperature of the image presented on the surface of the windshield 120 by the display region DR and the peripheral region PR when a non-polarized light beam irradiates the display region DR and the peripheral region PR of the display 100 according to another embodiment; and the differences in brightness, color difference, and color temperature of the image presented on the surface of the windshield 120 by the display region DR and the peripheral region PR when a light beam with the second polarization direction P2 irradiates the display region DR and the peripheral region PR of the display 100 according to another embodiment.

Referring to FIG. 1A and FIG. 1B, when the initial ambient light L2 irradiates the display 100, reflection occurs, which may be divided into stray light L2A formed by reflection from the display region DR, and stray light L2B formed by reflection from the peripheral region PR. The stray light may be reflected onto the windshield 120 where no optical film 110 is disposed, and be further reflected (for example, stray light L2′ in FIG. 1B). When the stray light L2′ is transmitted to the eye e of the user, the user may see a frame mura defect q due to the differences in reflectance, specular reflectance, brightness, color difference, and/or color temperature, which affects the user's viewing experience.

Here, the optical parameters shown in Table 1-1 and Table 1-2 (or Table 2-1 and Table 2-2) may be achieved by disposing the optical film 110, so as to obtain the differences in reflectance, specular reflectance, brightness, color difference, and/or color temperature that conform to the specifications in the above tables, and reduce the visibility of the frame mura defect q and mitigate the influence of stray light generated by the display module 1A. In some embodiments, when the display 100 is not displaying (for example, powered off or in a standby mode) or is in a black screen state, the difference in reflectance between the peripheral region PR and the display region DR may be less than 1%, and the difference in specular reflectance between the peripheral region PR and the display region DR may be less than 1%. In some embodiments, when the display 100 is not displaying or is in a black screen state, the color difference between the peripheral region PR and the display region DR may be less than 1%.

Referring to FIG. 2A, the display module 1B is similar to the display module 1A in FIG. 1A. The main differences between the display module 1B and the display module 1A will be described below. The display module 1B further includes at least one light absorption component 130, which is disposed adjacent to at least one side of the peripheral region PR and is separated from the display 100 by a distance d1 in the direction X. Specifically, as shown in the enlarged view of region C, the light absorption component 130 may include a light absorption layer 131 and a fixing component 132 for fixing the light absorption layer 131. The fixing component 132 may have a first surface S1 parallel to the direction Y and a second surface S2 parallel to the direction X. The first surface S1 and the second surface S2 face the display 100, and the direction X may be substantially perpendicular to the direction Y, for example, but the disclosure is not limited thereto. The light absorption layer 131 may be directly disposed on the first surface S1 and the second surface S2, which means that the light absorption layer 131 also faces the display 100.

The light absorption component 130 may be disposed on the transmission path of the initial ambient light L2 reflected by the display 100. The light absorption layer 131 of the light absorption component 130 may include leather, ink, fabric, polarizer, or other suitable absorption materials, or may include, for example, a material with a higher absorption rate for a light beam with the second polarization direction P2, or an optical layer with anti-glare motheye structures, thin-film optical structures, or other light absorption structures on the surface, so as to keep the specular reflectance of the light absorption component 130 less than or equal to 1%, but the disclosure is not limited thereto. The position or shape of the light absorption layer 131 may be adjusted mechanically (for example, moved, rotated, or enlarged) by the fixing component 132, but the disclosure is not limited thereto. With the light absorption component 130, the reflection of the initial ambient light L2 at the display 100 can be further absorbed, which also reduces unexpected reflection of the initial ambient light L2, thereby suppressing the generation of stray light, reducing the influence of stray light on the eye e, and thus improving the image clarity and contrast of the display light L1.

Further, to improve the light absorption effect of the light absorption component 130, various dimensional parameters between the light absorption component 130 and the display 100 are designed correspondingly. For example, the distance d1 is the minimum spacing between the display 100 and the light absorption layer 131, and the distance d1 may be less than or equal to the orthographic projection of the width of the display 100 on the horizontal plane (for example, the plane where the direction X lies). For instance, in the case where the inclination angle of the display 100 relative to the direction X is Φ, and the width of the display 100 is W, the distance d1 is less than or equal to W*tan Φ. The height h1 is the vertical height of the display 100 in the direction Y, and the height h2 is the vertical height of the light absorption layer 131 in the direction Y. In some embodiments, the height h2 may be greater than the height h1, thereby improving the light absorption function of the light absorption component 130. In some embodiments, the surface of the at least one light absorption component 130 facing the display 100 is not parallel to the surface of the display 100. For example, the inclination angle @ of the display 100 relative to the direction X may be greater than 0 degrees and less than 45 degrees to allow the driver (for example, the eye e in the drawing) to see an upright virtual image. Additionally, the depth g1 is the difference between the highest point position of the display 100 and the highest point position of the light absorption layer 131 in the direction Y. If the depth g1 is too large, the display light L1 may be easily blocked by the light absorption component 130, which affects the display effect; however, if the depth g1 is too small, the effect of the light absorption component 130 in absorbing the initial ambient light L2 (or stray light) may be affected. In some embodiments, the depth g1 satisfies the following condition: 0.5*h1<g1<5*h1. Accordingly, the light absorption component 130 exerts a better light absorption function.

It is worth mentioning that the display 100 may further include other optical structures to further suppress the generation of stray light. As shown in the enlarged view of region D, the first side edge ed1 of the frame 102 of the display 100 (or the second side edge ed2 in FIG. 1A) may include microstructures 1021. The microstructures 1021 are, for example, multiple triangular prisms to increase the proportion of the initial ambient light L2 in the peripheral region PR that is diffusely reflected, which not only reduces the generation of glare but also makes it easy to guide the initial ambient light L2 irradiating the display 100 to the light absorption component 130 for effective absorption. In other embodiments, the microstructures 1021 may be implemented in various forms. For example, in FIG. 2B, the microstructures 1021 may be replaced with microstructures 1021A, which are multiple semi-cylindrical bodies of consistent size and regular arrangement. The semi-cylindrical bodies generally refer to incomplete cylindrical bodies, and are not limited to half of cylindrical bodies. Alternatively, the microstructures 1021 may be replaced with microstructures 1021B, which are multiple semi-cylindrical bodies of different sizes and irregular arrangement. Alternatively, the microstructures 1021 may be replaced with microstructures 1021C, which are multiple trapezoidal prisms of consistent size. Nevertheless, the disclosure is not limited thereto.

Referring to FIG. 2A again, the cover plate 103 may have a flat portion FP corresponding to the display region DR, and a curved portion CP adjacent to the peripheral region PR. The curved portion CP makes it easy for the initial ambient light L2 irradiating the display 100 to be guided to the light absorption component 130 and absorbed by the light absorption component 130, which further suppresses the generation of stray light. Additionally, an anti-glare layer AG may be disposed on the cover plate 103. The anti-glare layer AG may be disposed on the curved portion CP and the flat portion FP to further reduce the generation of glare. In other embodiments, the cover plate 103 may also include an anti-reflection film with a frosted surface, which further reduces the reflectance of the cover plate 103 and suppresses the generation of stray light.

Referring to FIG. 3, the display module 1C is similar to the display module 1B in FIG. 2A, and the main differences will be described below. In the display module 1C, the angle of the display light L1 emitted by the display module 1C may be further adjusted to achieve a better imaging effect with the display light L1. For example, in the enlarged view of region E, there is an angle θ1 between the normal N2 of the surface of the display 100 and the normal N1 of the windshield 120. In addition, the light emission range of the display light L1 may have a full width at half maximum (FWHM) θ2. The full width at half maximum is defined as the corresponding angular range when the brightness observed by the display 100 is reduced to half. In this embodiment, the angle θ1 may be greater than the full width at half maximum θ2. The above configuration can provide the display effect of a narrow viewing angle. In some embodiments, the full width at half maximum θ2 may be less than 15 degrees, less than 30 degrees, or less than 45 degrees, but the disclosure is not limited thereto.

Referring to FIG. 4, the display module 1D is similar to the display module 1B in FIG. 2A, and the main differences will be described below. In the display module 1D, the light absorption component 130 is, for example, disposed on a side away from the position of the driver (for example, the position of the eye e). From another perspective, the light absorption component 130 is disposed between the display 100 and the windshield 120 in the direction X. Correspondingly, the light absorption layer 131 is disposed facing the display 100 to absorb the initial ambient light L2 reflected by the surface of the display 100. Specifically, the position of the light absorption component 130 may be adjusted according to the angle of the windshield 120. The configuration of this embodiment is applicable to a vehicle (for example, truck or SUV) with a larger inclination angle of the windshield 120 (for example, a larger inclination angle relative to the direction X). Basically, the height of the light absorption component 130 does not block the full width at half maximum θ2 of the display light L1, so as to reduce the influence on the imaging of the display 100. In some embodiments, the display light L1 may have an asymmetric viewing angle. For example, the maximum brightness of the display light L1 irradiating the surface of the optical film 110, the angle relative to the normal N1 may be greater than 5 degrees, greater than 10 degrees, or greater than 15 degrees.

Referring to FIG. 5, the display module 1E is similar to the display module 1D in FIG. 4, and the main differences will be described below. The display module 1E further includes a support component 140, which is disposed between the windshield 120 and the display 100, and the optical film 110 is attached to the support component 140. In other words, the optical film 110 and the windshield 120 are separated from each other. The support component 140 includes, for example, a transparent plastic material or other plate materials with a high transmittance to visible light, and may have a support structure that can rotate, move, and/or fold. Nevertheless, the disclosure is not limited thereto. In some embodiments, the inclination angle of the support component 140 may be different from the inclination angle of the windshield 120. Since the optical film 110 is attached to the support component 140, the optical film 110 may be replaced simply by removing the support component 140, which achieves the purpose of reducing maintenance costs.

Referring to FIG. 6, the display module 1F is similar to the display module 1D in FIG. 4, and the main differences will be described below. The display module 1F may further include another light absorption layer 150, which is disposed between the optical film 110 and the windshield 120. The another light absorption layer 150 is, for example, a light absorption layer with a high absorption rate for the second polarization direction P2 (for example, an absorptive polarizer), an adhesive layer with carbon black particles, dark ink, or an adhesive layer with a light absorption material.

In the enlarged region F, the optical film 110 has a higher first reflectance for the display light L1 with the first polarization direction P1, so the display light L1 is easily reflected by the optical film 110 to the eye e, with small part of the display light L1 passing through the optical film 110 and being absorbed by the another light absorption layer 150. Additionally, since the optical film 110 has a higher second transmittance for the initial ambient light L2 with the second polarization direction P2, the initial ambient light L2 with the second polarization direction P2 easily passes through the optical film 110 and is then absorbed by the another light absorption layer 150. In other words, disposing the another light absorption layer 150 helps to reduce the chance of the initial ambient light L2 being transmitted to the eye e, or reduce the chance of the initial ambient light L2 forming stray light inside the vehicle. Therefore, the image quality of the display module IF is improved. On the other hand, the proportion of reflected light in S-type polarization state in the initial ambient light L2 is relatively high. Therefore, the another light absorption layer 150 with a corresponding polarization absorption direction can reduce the proportion of the initial ambient light L2 that enters the vehicle.

Referring to FIG. 7A, the display module 1G is similar to the display module 1D in FIG. 4, and the main differences will be described below. The display module 1G may further include a protective layer 160 disposed on the optical film 110. From another perspective, the optical film 110 may be disposed between the windshield 120 and the protective layer 160. The protective layer 160 may include a glass material, a plastic material, or other materials with a high transmittance to visible light, and be configured to protect the optical film 110.

As shown in the enlarged view of region G, when the display light L1 is transmitted to the protective layer 160, part of the display light L1 may be reflected by the first surface 160S1 of the protective layer 160 facing the display 100 to generate, for example, the first reflected light LIA, and part of the display light L1 may be reflected by the second surface 160S2 of the protective layer 160 facing away from the display 100 to generate, for example, the second reflected light LIB. The first reflected light LIA and the second reflected light LIB result in multiple images, which are likely to cause ghost images to the eye e and affect the quality of the displayed image.

Referring to FIG. 7B, FIG. 7B shows the relationship between the incident angle and the reflection coefficient for a light beam with the first polarization direction P1 and a light beam with the second polarization direction P2. FIG. 7B illustrates a case where light beams of different polarization directions enter a medium with a refractive index n=1.5 from a medium with a refractive index n=1. According to the graph, when the incident angle approaches the Brewster's angle, the light beam with the first polarization direction P1 (for example, the display light L1) can have the minimum reflection coefficient. Therefore, when the incident angle is at the Brewster's angle, the intensity of the first reflected light LIA can be minimized, thus further reducing the ghost image phenomenon. Thus, the angle θ1 (that is, the angle between the normal N2 of the display surface of the display 100 and the normal N1 of the windshield 120, with the normal N2 omitted in FIG. 7A) can be close to the Brewster's angle. From another perspective, the Brewster's angle is related to the refractive indices of the two different media through which the light beam passes. Therefore, in this embodiment, the refractive index of the protective layer 160 may be greater than or equal to 1.3 and less than or equal to 1.8. The above configuration can significantly suppress the generation of the first reflected light LIA, thereby reducing the generation of ghost images.

In some embodiments, multiple displays 100 may be provided, and the multiple displays 100 may respectively correspond to positions with different curvatures on the windshield 120. Different displays 100 may have different angles θ1. Alternatively, the angles θ1 of different displays 100 may be substantially the same, and protective layers 160 including different materials may be selected to adjust to different refractive indices, so as to achieve the aforementioned effect. Alternatively, multiple support components 140 with different inclination angles may be used under the structure of FIG. 5.

Referring to FIG. 8, the display module 1H is similar to the display module 1D in FIG. 4, and the main differences will be described below. The display module 1G may further include a phase retardation plate 170, which is disposed on the optical film 110, or from another perspective, the optical film 110 may be disposed between the windshield 120 and the phase retardation plate 170. As shown in region H, the phase retardation plate 170 may be, for example, a quarter-wave plate, which can transform the polarization state of the display light L1 from the first polarization direction P1 to a third polarization direction P3 (for example, elliptical polarization or circular polarization). Similarly, the phase retardation plate 170 can transform the polarization state of the initial ambient light L2 from the second polarization direction P2 to another third polarization direction P3′ (for example, elliptical polarization in another direction or circular polarization in another direction). The disclosure is not intended to limit the type and/or form of the phase retardation plate 170.

The driver may sometimes wear sunglasses SG to shade sunlight when driving. Today's linearly polarized sunglasses SG are, for example, suitable for absorbing a S-type polarized light beam and allowing a P-type polarized light beam to pass through. By disposing the phase retardation plate 170, the driver wearing the sunglasses SG can receive the initial ambient light L2 passing through the optical film 110 and the phase retardation plate 170. In other words, the driver can see the environment outside the windshield 120, which improves driving safety.

In summary, the display module according to the disclosure reduces the generation of stray light in the display module with the optical film, which helps to improve the contrast of the display light or improve the display quality. In addition, the light absorption component disposed in the display module further achieves the effect of suppressing the generation of stray light.

The above embodiments simply serve to illustrate the technical solutions of the disclosure, but not to limit them; although the disclosure has been described in detail with reference to the foregoing embodiments, any person having ordinary knowledge in the art should understand that the technical solutions described in the foregoing embodiments can still be modified, or some or all of the technical features thereof can be equivalently replaced, and these modifications or substitutions do not make the essence of the corresponding technical solutions deviate from the scope of the technical solutions of the embodiments of the disclosure.

Although the embodiments of the disclosure and their advantages have been disclosed as above, it should be understood that any person having ordinary knowledge in the art can make changes, substitutions and modifications without departing from the spirit and scope of the disclosure, and the features of each embodiment can be arbitrarily mixed and replaced with each other to form other new embodiments. In addition, the protection scope of the disclosure is not limited to the process, machine, manufacture, material composition, device, method and steps in the specific embodiments described in the specification; any person having ordinary knowledge in the art can understand the present or future developed processes, machines, manufactures, compositions, devices, methods and steps from the disclosure, and anything that can perform substantially the same functions or achieve substantially the same results in the embodiments described herein can be used in accordance with the disclosure. Therefore, the protection scope of the disclosure includes the above-mentioned processes, machines, manufactures, material compositions, devices, methods and steps. In addition, each claim constitutes a separate embodiment, and the scope of the disclosure also includes combinations of each claim and the embodiment. The scope of protection of the disclosure shall be defined by the appended claims.

What is claimed is:

1. A display module, disposed adjacent to a windshield, the display module comprising:
a display comprising a display region and a peripheral region, and configured to provide display light with a first polarization direction;
an optical film disposed on a side adjacent to a light-emitting surface of the display, and configured to reflect the display light with the first polarization direction; and
at least one light absorption component disposed adjacent to at least one side of the peripheral region and separated from the display by a distance.

2. The display module according to claim 1, wherein a surface of the at least one light absorption component facing the display is not parallel to a surface of the display, and a specular reflectance of the at least one light absorption component is less than or equal to 1%.

3. The display module according to claim 1, wherein the optical film has a first surface and a second surface, and
the display light is incident on the first surface, and initial ambient light is incident on the second surface, wherein the initial ambient light has a second polarization direction, and the optical film allows the initial ambient light with the second polarization direction to pass through.

4. The display module according to claim 3, wherein the initial ambient light further has the first polarization direction, and the optical film reflects the initial ambient light with the first polarization direction.

5. The display module according to claim 3, wherein the optical film has a first reflectance and a first transmittance for a light beam with the first polarization direction, and the optical film has a second reflectance and a second transmittance for a light beam with the second polarization direction,
wherein the first reflectance is greater than the second reflectance, and the first transmittance is less than the second transmittance.

6. The display module according to claim 1, wherein a reflectance of the optical film is greater than or equal to 25% and less than or equal to 35%, and a transmittance of the optical film is greater than or equal to 65% and less than or equal to 75%.

7. The display module according to claim 1, wherein the display further comprises:
a display panel configured to provide the display light;
a frame configured to accommodate the display panel;
a cover plate disposed on a light-emitting surface of the display panel; and
a light-shielding layer disposed on the cover plate,
wherein the peripheral region comprises a part of the cover plate, the frame, and the light-shielding layer.

8. The display module according to claim 1, wherein when the display is not displaying or is in a black screen state, a difference in reflectance between the peripheral region and the display region is less than 1%.

9. The display module according to claim 8, wherein when the display is not displaying or is in the black screen state, a difference in specular reflectance between the peripheral region and the display region is less than 1%.

10. The display module according to claim 1, wherein when the display is not displaying or is in a black screen state, a color difference between the peripheral region and the display region is less than 1%.

11. The display module according to claim 1, further comprising a support component disposed between the windshield and the display, wherein the optical film is attached to the support component.

12. The display module according to claim 1, further comprising a light absorption layer disposed between the optical film and the windshield.

13. The display module according to claim 1, further comprising a protective layer, wherein the optical film is disposed between the windshield and the protective layer.

14. The display module according to claim 13, wherein a refractive index of the protective layer is greater than or equal to 1.3 and less than or equal to 1.8.

15. The display module according to claim 1, further comprising a phase retardation plate, wherein the optical film is disposed between the windshield and the phase retardation plate.

16. The display module according to claim 7, wherein a side edge of the frame comprises a plurality of microstructures, and shapes of the plurality of microstructures comprise triangular prisms, semi-cylindrical bodies, or trapezoidal prisms.

17. The display module according to claim 16, wherein the cover plate comprises a flat portion overlapping the display region and a curved portion overlapping the peripheral region, and the curved portion is disposed between the flat portion and the side edge.

18. The display module according to claim 7, further comprising an anti-glare layer disposed on the cover plate.

19. The display module according to claim 1, wherein the at least one light absorption component further comprises a light absorption layer and a fixing component, and the light absorption layer is disposed on the fixing component.

20. The display module according to claim 19, wherein the fixing component has a first surface parallel to a first direction and a second surface parallel to a second direction, and
the light absorption layer is disposed on the first surface and the second surface, wherein in the first direction, the at least one light absorption component is located between the display and a user.
